(19) United States
(12) Patent Application Publication
(10) Pub. No.: US 2020/0093159 A1
(43) Pub. Date: Mar. 26, 2020

(54) Compositions and Methods for Reducing Sugar Content in Juices

(71) Applicant: Tropicana Products, Inc., Bradenton, FL (US)

(72) Inventors: Teodoro Rivera, Algonquin, IL (US); Lisa Handrick, Palatine, IL (US); Kyle McLean, Chicago, IL (US); Jason Casuga Parcon, Hoffman Estates, IL (US); Gary D. Carder, Barrington Hills, IL (US)

(21) Appl. No.: 16/577,407

(22) Filed: Sep. 20, 2019

Related U.S. Application Data
(60) Provisional application No. 62/736,315, filed on Sep. 25, 2018.

(51) Int. Cl. A23L 2/02; A23L 2/60

(52) U.S. Cl. CPC A23L 2/02; A23V 2002/00; A23L 2/60

(57) ABSTRACT

Juice beverages are disclosed. The juice beverages include a juice base, a first lower-calorie liquid and a second lower-calorie liquid. The juice beverage has fewer calories per serving than the juice base alone, yet retains an organoleptic attribute profile that is similar to the organoleptic attribute profile of the juice base.

This application claims priority to US Patent Application 62/736,315 filed Sep. 25, 2018, the entire contents of which is incorporated herein by reference.

### TECHNICAL FIELD

The present disclosure relates generally to juice products and, more particularly, to juice beverages that include one or more low-sugar juices.

### BACKGROUND

One hundred percent juices are often desirable to consumers looking to consume natural ingredients such as fruits and vegetables. These types of juices may include fruit juices, vegetable juices, concentrates, purees, nectars, and other ingredients obtained from fruits and vegetables.

Some consumers have become increasingly concerned with limiting caloric intake from juice. Typically, juices consumed as beverages contain from 10 grams of sugar to 40 grams of sugar per 250 mL serving. Although sugar is not typically added to 100% juices, it is naturally present in fruits and vegetables.

Low-calorie foods may, in some instances, lack flavor as compared to their full-calorie counterpart foods. For example, consumers may perceive some low-calorie foods as insufficiently sweet. Manufacturers have tried to counter this problem by adding sugar substitutes and flavorings to make the low-calorie food taste more like its full-calorie counterpart. For example, low-calorie orange juice products have been produced by diluting orange juice with drinking water and adding sweeteners, coloring, and flavoring. However, some consumers can still detect differences between such products and their full-calorie counterparts. Furthermore, certain artificial ingredients, including sweeteners, are often not well-received by some consumers.

### SUMMARY

The present disclosure relates to juice beverages having reduced calorie content. In a first embodiment, novel aspects of the present disclosure are directed to a juice beverage comprising from about 40 wt. % to about 85 wt. % of a juice base having a Brix value from about 7.5° Bx to about 25° Bx. In addition, the juice base has at least one fruit juice. The juice beverage includes from about 5 wt. % to about 35 wt. % of a first liquid that is a juice and has a Brix value from about 2° Bx to about 7° Bx. The juice beverage also includes from about 3 wt. % to about 30 wt. % of a second liquid that is a juice and has a Brix value from about 1° Bx to about 6° Bx, the Brix value of the second liquid being lower than the Brix value of the first liquid.

In a second embodiment, novel aspects of the present disclosure are directed to a method of making a juice beverage. A juice base comprising at least one fruit juice and a Brix value from about 7.5° Bx to about 25° Bx is provided. A first liquid, which is a juice and has a Brix value from about 2° Bx to about 7° Bx, is also provided. A second liquid, which is a juice and has a Brix value from about 1° Bx to about 6° Bx, is also provided. In addition, the Brix value of the second liquid is lower than the Brix value of the first liquid. Thereafter, the juice base is combined with the first liquid and the second liquid to produce the juice beverage, which has from about 40 wt. % to about 85 wt. % of the juice base, from about 5 wt. % to about 35 wt. % of the first liquid, and from about 3 wt. % to about 30 wt. % of the second liquid.

In a third embodiment, novel aspects of the present disclosure are directed to a juice beverage comprising a juice base, a first liquid, and a second liquid. The juice base, which includes at least one fruit juice, has a first Brix value. The first liquid is a juice with a second Brix value, and the second liquid is a juice with a third Brix value that is lower than the second Brix value. In addition, the juice beverage has a fourth Brix value that is 20% to 40% lower than the first Brix value.

These and other objects, along with advantages and features of the present disclosure, will become apparent through reference to the following description and the accompanying drawing. Furthermore, it is to be understood that the features of the various embodiments described herein are not mutually exclusive and can exist in various combinations and permutations.

### BRIEF DESCRIPTION OF THE DRAWINGS

The detailed description particularly refers to the following FIGURE, in which:

FIG. 1 is a principle component analysis chart depicting sensory attributes determined for formulations having varying amounts of orange juice, coconut water, and lettuce juice.

### DETAILED DESCRIPTION

While the concepts of the present disclosure are susceptible to various modifications and alternative forms, specific exemplary embodiments thereof have been shown by way of example in the drawing and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

The present disclosure relates generally to juice beverages, such as 100% juice beverages, having reduced calorie content. In particular, a juice beverage of the present disclosure may have organoleptic properties that are similar to, substantially the same as, or the same as the organoleptic properties of a juice base used to make the juice beverage, while containing fewer calories per serving than the juice base alone. Organoleptic properties include, without limitation, those properties related to aroma, flavor, mouthfeel, texture, or aftertaste. More specific examples of organoleptic properties can include, without limitation, citrus flavor, orange flavor, fresh/raw orange flavor, total vegetable flavor, celery flavor, cucumber flavor, sweetness, saltiness, bitterness, astringent flavor, viscosity, and mouth drying.

Juice beverages described herein include mixtures of juices. As used herein, the term “juice” is defined as a liquid extracted from a fruit, vegetable or plant. Examples of juices include, without limitation, fruit juice, vegetable juice, plant juice, plant water, and plant sap. Examples of juices also include juices that are reconstituted from-concentrate (FC) juices, not-from-concentrate (NFC) juices, purees, nectars or combinations thereof. The juice beverages described herein include a juice base and one or more liquids comprising a juice having fewer calories per serving than the juice base. The juice beverages described herein have desirable organoleptic attributes (for example, organoleptic attributes similar to those of the juice base), while also having fewer calories per serving and less sugar per serving than the juice base. In some embodiments, the one or more lower-calorie liquids may, when evaluated alone, have one or more undesirable organoleptic attributes. However, the combination of juice base and one or more lower-calorie juices synergistically form a juice blend having a desirable organoleptic profile that eliminates or attenuates undesirable attributes of the one or more lower-calorie juices.

As is further discussed herein, the juice beverage may comprise juice from two or more natural sources. Natural sources include but are not limited to fruits, vegetables, and other plants. In some embodiments, the juice beverage is made entirely of ingredients from natural sources. For example, in some embodiments, the juice beverage is 100%, about 100%, greater than about 99.9%, greater than about 99% juice by weight.

The combination of juices that make up the juice beverage is chosen such that the organoleptic properties of the juice beverage are similar to, substantially the same as, or the same as that of the juice base, as determined by a trained sensory panel. For example, in some embodiments the juice beverage is based on apricot juice, apple juice, orange juice, melon juice, grapefruit juice, lemon juice, lime juice, tangerine juice, tangelo juice, kumquat juice, mango juice, pear juice, peach juice, pineapple juice, papaya juice, passion fruit juice, grape juice, strawberry juice, raspberry juice, currant juice, blueberry juice, blackberry juice, acai juice, lychee juice, kiwi juice, pomegranate juice, aronia juice, cranberry juice, banana juice, a green juice, or a combination of the foregoing, and the like. As used herein, a “green juice” refers to a juice having a naturally green color and may include one or more juices selected from the group consisting of sweet potatoes, grapes, apples, bananas, mangoes, pineapple, oranges, carrots, limes, kale, and spinach. It is understood that “green juice” must include at least one ingredient that is naturally green in color, but may also include other ingredients that are not green in color, such as lemon.

In some embodiments, the juice beverage is based on orange juice, apple juice, pear juice, grape juice, pineapple juice, cranberry juice, strawberry juice, mango juice, pomegranate juice, grapefruit juice, a green juice, or a combination of the foregoing. In preferred embodiments, the juice beverage is based on orange juice, apple juice, or a green juice.

The juice beverages of the present disclosure may include fruit juices, vegetable juices, concentrates, purees, nectars, or other ingredients obtained from fruits, vegetables, or other plants. In some embodiments, the juice beverages are made entirely of ingredients from natural sources. Alternatively, the juice beverages may include one or more non-natural ingredients. Optionally, the juice beverages may be made entirely from organic ingredients. The juice beverages may optionally be made entirely from non-GMO ingredients.

Examples of fruit juices, vegetable juices, and plant waters that may be employed in connection with the present disclosure include but are not limited to those derived from apricot, apple, orange, melon, grapefruit, lemon, lime, tangerine, coconut, tangelo, kumquat, mango, pear, peach, pineapple, cranberry, banana, papaya, passion fruit, grape, strawberry, raspberry, currant, blueberry, blackberry, acai, lychee, kiwi, pomegranate, aronia, watermelon, lettuce, kale, spinach, collard greens, Swiss chard, arugula, tomato, celery, onion, watercress, cucumber, carrot, parsley, cilantro, basil, mint, fennel, dill, beet, ginger, wheat grass, asparagus, potato, sweet potato, turnip, rutabaga, algae, marine-derived grass, leaves, rinds, trees, grains, grasses, bamboo, birch, maple, artichoke, olive, cactus, aloe, sugarcane, barley, combinations thereof, and the like.

In another aspect of any one of the embodiments of the present disclosure, the juice beverage includes a juice base made of one or more juices. In some embodiments, the juice base includes at least one fruit juice.

For example, the juice base may include a juice selected from the group consisting of orange, apple, pear, grape, strawberry, banana, a green juice, and combinations thereof. For example, the juice base may be orange juice. For example, the juice base may be a mixture of orange juice and strawberry juice. For example, the juice base may be a green juice. For example, the green juice may comprise sweet potato, grape, apple, banana, mango, pineapple, orange, carrot, lime, kale, and spinach. For example, the juice base may be apple juice.

The juice base has a concentration of sugar greater than that of the resulting juice beverage. The amounts of sugar in the juice beverage, juice base, or lower-calorie liquids of the present disclosure may be measured in terms of grams of sugar per mL. For example, the sugar content of the juice base may be from about 10 to about 40, about 15 to about 40, about 20 to about 40, about 25 to about 40, about 30 to about 40, about 10 to about 35, about 15 to about 35, about 20 to about 35, about 25 to about 35, about 30 to about 35, or about 25 grams of sugar per 250 mL.

Alternatively, the concentration of sugar in a juice beverage, juice base, or lower-calorie liquid may be expressed in terms of Brix. As used herein, “Brix” values are based on a refractive index obtained at a temperature of 20° C. according to the Harmonized Tariff Schedule of the United States (HTSUS), Revision 9. Additionally, the Brix value of a particular juice refers to the Brix level of that juice in single-strength form (i.e., not from concentrate or reconstituted from concentrate). For example, FC orange juice has a Brix value that is comparable to NFC orange juice even when it is diluted from a juice concentrate format. In the United States, the standard identity for orange juice made from concentrate is at least 11.8° Bx.

The juice base may have a Brix level from about 7.5 to about 25° Bx. The present invention is most effective when the Brix level of the juice base is between 10 and 25° Bx. Effectively reducing the Brix level of a juice base having a Brix of greater than 10° Bx is highly challenging because such juice bases are widely perceived as sweet beverages. Thus, the technical challenge of reducing the Brix level without negatively affecting the organoleptic attributes associated with the juice base is significant, and gets increasingly difficult at increasing Brix levels of the juice base. In a most preferred embodiment, the juice base has a Brix level of from about 11 to about 15° Bx. In another embodiment, the juice base has a Brix level above 10° Bx, and the juice beverage has a Brix level below 10° Bx.

The amount of the juice base present in the juice beverage may be from about 40% to about 85% by weight of the juice beverage. In a preferred embodiment, the amount of the juice base present in the juice beverage may be from about 50% to about 80% by weight of the juice beverage.

The juice base is mixed with one or more liquids, with each liquid having lower calorie content per serving than the juice base. The lower-calorie liquids may be juices (for example, fruit juices, vegetable juices, and/or plant waters). The one or more lower-calorie liquids may be derived from plant material. Additionally, the one or more lower-calorie liquids are complementary with the juice base and/or other lower-calorie liquids, allowing for a desirable organoleptic profile. In particular, the lower-calorie liquids may be selected such that the juice beverage has an organoleptic profile similar to that of the juice base alone, but without undesirable attributes or with limited undesirable attributes that may be associated with the one or more of the lower-calorie liquids, individually.

A lower-calorie liquid of the present disclosure may include juice, plant water, plant juice, or plant sap selected from the group consisting of coconut, watermelon, beet, ginger, potato, turnip, rutabaga, bamboo, birch, maple, cactus, aloe, sugarcane, barley, lettuce, collard greens, Swiss chard, arugula, watercress, winter melon, tomato, celery, onion, cucumber, parsley, cilantro, basil, mint, fennel, dill, wheat grass, asparagus, artichoke, olive, and the like.

A lower-calorie liquid employed in connection with the present disclosure has a lower concentration of sugar compared to the sugar concentration of the juice base. The sugar concentration of any of the lower-calorie liquids of the present disclosure may be measured in terms of grams of sugar per mL of liquid. For example, the sugar content of the lower-calorie liquid may be from about 1 to about 20, about 1 to about 15, about 1 to about 12, about 1 to about 10, about 1 to about 8, about 1 to about 5, about 1 to about 3, about 1 to about 2, about 3 to about 20, about 3 to about 15, about 3 to about 12, about 3 to about 10, about 3 to about 8, about 3 to about 5, about 5 to about 20, about 5 to about 15, about 5 to about 12, about 5 to about 10, about 5 to about 8, about 8 to about 20, about 8 to about 15, or about 8 to about 12, or about 8 to about 10 grams of sugar per 250 mL of liquid.

Alternatively, the sugar concentration may be expressed in terms of Brix. The lower-calorie liquid may have a Brix level from about 1 to about 7° Bx. In a preferred embodiment, the lower-calorie liquid may have a Brix level from about 2 to about 6° Bx.

In some embodiments, the juice base is mixed with at least two of the lower-calorie liquids described herein. The first and second lower-calorie liquids may be complementary with each other such that undesirable attributes that may be associated either or both of the first and second lower-calorie liquids are attenuated. In particular, undesirable attributes may become less significant when the juice beverage is evaluated by a trained sensory panel. As such, the first and second lower-calorie liquids may allow for a desirable organoleptic profile in the juice beverage.

The first lower-calorie liquid may include juice selected from the group consisting of coconut, watermelon, beet, ginger, potato, turnip, rutabaga, bamboo, birch, maple, cactus, aloe, sugarcane, barley, and the like. For example, in some embodiments, the first lower-calorie liquid is coconut water.

Coconut water comprises a clear to opaque liquid found inside coconuts. This liquid may be extracted from the coconut by drilling a hole into or otherwise opening the exterior of the coconut to access the interior. Coconut water may be formed from a concentrate or a puree. In some embodiments, other parts of the coconut may be included in coconut water, such as the pulp, milk, or oil. Coconuts used to make coconut water may be procured from tall, hybrid, or dwarf coconut trees from various parts of the world.

In some embodiments, the sugar content of the first lower-calorie liquid may be from about 3 to about 20, about 3 to about 15, about 3 to about 12, about 3 to about 10, about 3 to about 8, about 3 to about 5, about 5 to about 20, about 5 to about 15, about 5 to about 12, about 5 to about 10, about 5 to about 8, about 8 to about 20, about 8 to about 15, about 8 to about 12, or about 8 to about 10 grams per 250 mL of liquid.

Alternatively, the sugar content of the first lower-calorie liquid may be expressed in terms of Brix. The first lower-calorie liquid may have a Brix level from about 2 to about 7° Bx. In a preferred embodiment, the first lower-calorie liquid has a Brix level from about 2 to about 6° Bx.

In some embodiments, the first lower-calorie liquid has salty, nutty, or sweaty flavor attributes. Combining the first lower-calorie liquid with the second lower-calorie liquid and/or the juice base may attenuate these flavor attributes.

The second lower-calorie liquid may include juice, plant water, plant juice, or plant sap selected from the group consisting of turnip, lettuce, collard greens, Swiss chard, arugula, watercress, tomato, celery, onion, cucumber, parsley, cilantro, basil, mint, fennel, dill, wheat grass, asparagus, artichoke, olive, and the like. For example, in some embodiments, the second lower-calorie liquid is lettuce juice.

Lettuce juice comprises a liquid extracted from lettuce using juicing methods. For example, lettuce juice may be extracted from lettuce using masticating, centrifugal, and/or triturating methods. For example, lettuce juice may be formed from a concentrate or a puree.

In some embodiments, the sugar content of the second lower-calorie liquid may be from about 1 to about 10, about 1 to about 8, about 1 to about 5, about 1 to about 3, about 1 to about 2, about 3 to about 10, about 3 to about 8, about 3 to about 5, about 5 to about 10, or about 5 to about 8 grams per 250 mL of liquid.

Alternatively, the sugar content of the second lower-calorie liquid may be expressed in terms of Brix. The second lower-calorie liquid may have a Brix level from about 1 to about 6° Bx. In a preferred embodiment, the second lower-calorie liquid has a Brix level from about 2 to about 5° Bx. In a most preferred embodiment, the second lower-calorie liquid has a Brix level from about 2 to about 4° Bx.

In some embodiments, the second lower-calorie liquid has vegetal flavor attributes. Combining the second lower-calorie liquid with the first lower-calorie liquid and/or the juice base may attenuate these flavor attributes.

In some embodiments, the second lower-calorie liquid has a lower sugar concentration than the sugar concentration of the first lower-calorie liquid. In particular, the second lower-calorie liquid may have a Brix value that is about 5% to about 90% lower than the Brix value of the first lower-calorie liquid. In a preferred embodiment, the second lower-calorie liquid has a Brix value that is about 10% to about 75% lower than the Brix value of the first lower-calorie liquid.

The amount of the first lower-calorie liquid present in the juice beverage may be from about 5% to about 35% by weight of the juice beverage. In a preferred embodiment, the first lower-calorie liquid is present in an amount from about 5% to about 30% by weight of the juice beverage.

The amount of the second lower-calorie liquid present in the juice beverage may be from about 3% to about 30% by weight of the juice beverage. In a preferred embodiment, the amount of the second lower-calorie liquid is from about 3% to about 25% by weight of the juice beverage.

In some embodiments, the juice base is orange juice, the first lower-calorie liquid is about 15 to about 30% by weight of the juice beverage, and the second lower-calorie liquid is about 2 to about 10% by weight of the juice beverage.

In some embodiments, the juice base is apple juice, the first lower-calorie liquid is about 15 to about 30% by weight of the juice beverage, and the second lower-calorie liquid is about 2 to about 10% by weight of the juice beverage.

In some embodiments, the juice base is a green juice, the first lower-calorie liquid is about 5 to about 15% by weight of the juice beverage, and the second lower-calorie liquid is about 15 to about 25% by weight of the juice beverage.

In some embodiments, the juice base is a fruit juice, the first lower-calorie liquid is coconut water and is about 15 to about 30% by weight of the juice beverage, and the second lower-calorie liquid is lettuce juice and is about 2 to about 10% by weight of the juice beverage.

In some embodiments, the juice base is a citrus juice, the first lower-calorie liquid is coconut water and is about 15 to about 30% by weight of the juice beverage, and the second lower-calorie liquid is lettuce juice and is about 2 to about 10% by weight of the juice beverage.

In some embodiments, the juice base is orange juice, the first lower-calorie liquid is coconut water and is about 15 to about 30% by weight of the juice beverage, and the second lower-calorie liquid is lettuce juice and is about 2 to about 10% by weight of the juice beverage.

In some embodiments, the juice base is apple juice, the first lower-calorie liquid is coconut water and is about 15 to about 30% by weight of the juice beverage, and the second lower-calorie liquid is lettuce juice and is about 2 to about 10% by weight of the juice beverage.

In some embodiments, the juice base is a green juice, the first lower-calorie liquid is coconut water and is about 5 to about 15% by weight of the juice beverage, and the second lower-calorie liquid is lettuce juice and is about 15 to about 25% by weight of the juice beverage.

In some embodiments, the ratio of the first lower-calorie liquid to the second lower-calorie liquid by weight may be from about 10:1 to about 1:1.

In some embodiments, the juice beverage is free or substantially free of additives. For example, the juice beverage may be free or substantially free of complementary flavors, sweeteners, maskers, and/or sugars.

In alternative embodiments, the juice beverage may include one or more additives. As used herein, an “additive” refers to an ingredient that is not a fruit juice, vegetable juice, or plant water. Illustrative additives include but are not limited to complementary flavors, sweeteners, maskers, and sugars.

In some embodiments, the juice beverage includes one or more additional plant components. Exemplary additional plant components may be selected from the group consisting of grains, herbs, and botanicals.

In some embodiments, the juice beverage includes one or more non-plant components, such as nutraceuticals, bioactives, or functional ingredients. Exemplary non-plant components may be selected from the group consisting of fatty acids such as omega-3 fatty acids, probiotics, prebiotics, vitamins, and minerals. For example, the juice beverage may include added vitamins and/or minerals, such as vitamin D and calcium.

In some embodiments, the juice beverage includes one or more flavor enhancers such as flavorings with modifying properties (FMPs). Flavor enhancers may be natural or non-natural ingredients. It is contemplated that flavor enhancers may be sweeteners. Exemplary sweeteners may be selected from the group consisting of sucralose, aspartame, saccharin, stevia, acesulfame potassium, erythritol, glycerol, cyclamate, lactitol, maltitol, sorbitol, xylitol, mannitol, monk fruit, advantame, isomalt, neotame, and the like, or a combination thereof. In some embodiments, the stevia comprises Rebaudioside A. Additionally, flavor enhancers may be oils from fruit or fruit peel. In some embodiments, flavor enhancers include oils from orange peel.

In some embodiments, the juice beverage includes about 0.001 to about 0.2 wt. % flavor enhancers. For example, the juice beverage may optionally comprise about 0.01 to about 0.1, or about 0.08 wt. % of FMPs. Furthermore, the juice beverage may optionally include about 0.001 to about 0.01, or about 0.006 wt. %, citrus oils.

In some embodiments the juice beverage includes pulp. In some embodiments, the juice beverage does not include pulp.

The juice beverage may also include one or more dairy products. The dairy products may be milk or a derivative thereof. Alternatively, the juice beverage may comprise one or more dairy substitutes such as soy milk, almond milk, rice milk, cashew milk, hemp milk, flax milk, or combinations thereof.

Some fruit juices, but more commonly, vegetable juices, have a naturally high pH, above 4.5. Depending on the pasteurization process, transport, and storage of the juice beverage, it may be desirable to acidify high pH juice ingredients or to acidify the juice beverage itself. Acidification can be accomplished by, for example, adding an acid such as citric acid or by adding high-acid juices to reduce pH levels. In some embodiments, pH levels of the juice beverage or juice ingredients are reduced to below about 4.5. In a preferred embodiment, the juice beverage comprises a pH below 4.5.

The juice beverages of the present disclosure may be formed by combining a juice base with one or more lower-calorie liquids. In some embodiments, a juice beverage may be formed from one or more from concentrate (FC) juices. In alternative embodiments, the juice beverage may be formed entirely from not from concentrate (NFC) juices. In other embodiments, the juice beverage may be formed from a combination of FC and NFC juices.

Juicing may be performed by various methods known in the art, including but not limited to masticating juicing, centrifugal juicing, and triturating methods. Masticating juicing, also known as cold-pressed juicing, may include the steps of shredding the fruit or vegetable, loading the contents into a porous filter bag, subjecting the bag to pressure, and collecting the resulting juice that is dispensed from the bag. Centrifugal juicing may include the steps of loading fruit or vegetable pieces into a porous basket having one or more spinning blades, where the contents are subjected to high speeds and juice passes through the basket while the pulp remains therein. Triturating juicing may utilize a dual auger system that crushes and grinds fruit or vegetable contents as they pass between augers, followed by extracting the resulting juice.

A resulting juice beverage of the present disclosure has a lower sugar concentration compared to the juice base used to make the juice beverage. The sugar concentration, as measured by grams of sugar per mL, in the juice beverage may be about 10% to about 75% lower than the grams of sugar per mL in the juice base used to make the juice beverage. In a preferred embodiment, the grams of sugar per mL in the juice beverage may be about 20% to about 50% lower than the grams of sugar per mL in the juice base used to make the juice beverage. In another preferred embodiment, the grams of sugar per mL in the juice beverage may be about 30% to about 75% lower than the grams of sugar per mL in the juice base used to make the juice beverage when the juice beverage includes a sweetener or flavor enhancer.

Similarly, the juice beverage has a lower Brix level compared to the juice base used to make the juice beverage. The Brix level of the juice beverage may be about 10% to about 75% lower than the Brix level of the juice base used to make the juice beverage. In a preferred embodiment, the Brix level of the juice beverage may be about 20% to about 50% lower than the Brix level of the juice base used to make the juice beverage. In another preferred embodiment, the Brix level of the juice beverage may be about 30% to about 75% lower than the Brix level of the juice base used to make the juice beverage when the juice beverage includes a sweetener or flavor enhancer.

Additionally, the resulting juice beverage has a lower calorie content per serving compared the juice base used to make the juice beverage. The amount of calories, as measured by calories per mL, in the juice beverage may be about 10% to about 75% lower than the amount of calories per mL in the juice base used to make the juice beverage. In a preferred embodiment, the amount of calories per mL in the juice beverage may be about 20% to about 40% lower than the amount of calories per mL in the juice base used to make the juice beverage. In another preferred embodiment, the amount of calories per mL in the juice beverage may be about 30% to about 75% lower than the amount of calories per mL in the juice base used to make the juice beverage, preferably when the juice beverage includes a sweetener or flavor enhancer.

The juice beverage may match or substantially match various attributes of its corresponding juice base. Similarity of attributes may be determined using Quantitative Descriptive Analysis (QDA®). The attributes may be evaluated by a trained sensory panel consisting of trained experts who compare attributes of the juice base to those of the juice beverage.

Attributes evaluated by the trained sensory panel may include aroma, flavor, mouthfeel, texture, and aftertaste. Additionally, attributes may include various appearance attributes including color, brightness, viscosity, opaqueness, and amount of pulp. Attributes may include various aroma attributes including fresh orange aroma, artificial orange aroma, citrus aroma, and bitter aroma. Attributes may include various flavor attributes including flavor strength, fruit juice flavor, fresh orange flavor, artificial orange flavor, pineapple flavor, coconut flavor, banana flavor, concentration, citrus flavor, total vegetable flavor, celery flavor, cucumber flavor, sweetness, saltiness, sourness, tanginess, bitterness, chemical flavor, stale flavor, and astringent flavor. Attributes may include various mouthfeel attributes including staleness, bite, and mouth drying.

In some embodiments, comparison of these attributes as measured using QDA® results in a fit to control value of greater than about 80, greater than about 85, greater than about 90, or greater than about 95%.

### EXAMPLES

Table 1 summarizes three exemplary blends, wherein each blend comprises a juice base, which is blended with lettuce juice and coconut water to produce a final blend (juice beverage) having a sensory profile similar to the juice base. Examples 1-4 are further described in the paragraphs that follow.

TABLE 1

| | | | | | | | Brix of | Brix | |
|---|---|---|---|---|---|---|---|---|---|
| | | Juice Base | Brix of | Lettuce Juice | Coconut Water | Added Flavors | Final Juice | Reduction | FTC |
| | Juice Base | (wt. %) | Juice Base | (wt. %) | (wt. %) | (wt. %) | Beverage | (%) | (%) |
| Example 1 | Orange Juice | 70 | 11.3 | 6.00 | 24.00 | 0 | 8.9 | −21.13 | 91.30 |
| Example 2 | Green Mixture | 70 | 12.2 | 20.60 | 9.40 | 0 | 9.4 | −22.74 | 82.70 |
| Example 3 | Apple Juice | 70 | 11.5 | 8.00 | 22.00 | 0 | 9.0 | −21.43 | 93.00 |
| Example 4 | Orange Juice | 69.914 | 11.3 | 6.00 | 24.00 | 0.086* | 8.9 | −21.13 | 96.5 |

*Flavors included 0.08 wt. % of FMP flavors and 0.006 wt. % of orange flavor (citrus oils/keys)

In Example 1 of Table 1, desirable concentrations of lettuce juice, coconut water, and orange juice were determined. In particular, descriptive analyses were used to obtain quantitative sensory attribute intensities of the juice blends tested. A design of experiments was conducted with 12 low-Brix liquids derived from various plant materials including lettuce, cucumber, celery, and coconut. Once the formulas were developed, samples were made in the pilot plant and tested for sensory attributes to generate composite fit to control (FTC) calculations. Attributes that were tested included aroma, flavor, mouthfeel, texture, and aftertaste. More specifically, attributes included citrus flavor, orange flavor, fresh/raw orange flavor, total vegetable flavor, celery flavor, cucumber flavor, sweetness, saltiness, bitterness, astringent flavor, viscosity, and mouth drying.

The composite FTC compares the sensory profile of the juice beverage with the sensory profile of the juice base quantified by percent match from 0% to 100%. The control is the juice base alone, and 100% represents the best sensory match of the juice beverage to juice base control. Brix and sugar reduction values are based on sugar content of the specific fruits and vegetables used in the experiments.

As shown in Table 2 below, Options 1-8 reflect a comparison of orange juice blended with lettuce juice, celery juice, cucumber juice, and/or coconut water. Using a 70% orange juice base, coconut water and lettuce juice each showed favorable results with FTC values of 90.1% and 88.2%, respectively.

TABLE 2

| | | | | | | | Brix |
|---|---|---|---|---|---|---|---|
| | Orange Juice | Lettuce Juice | Cucumber Juice | Celery Juice | Coconut Water | FTC | Reduction |
| Formulation | (wt. %) | (wt. %) | (wt. %) | (wt. %) | (wt. %) | (%) | (%) |
| Control | 100% | 0 | 0 | 0 | 0 | 100% | NA |
| Option 1 | 85% | 5.50% | 0 | 0 | 9.50% | 94.8% | 10.7% |
| Option 2 | 80% | 7% | 0 | 0 | 13% | 93.7% | 14.2% |
| Option 3 | 75% | 8% | 0 | 0 | 17% | 92.5% | 17.7% |
| Option 4 | 70% | 6% | 0 | 0 | 24% | 91.3% | 20.8% |
| Option 5 | 70% | 30% | 0 | 0 | 0 | 88.2% | 23.1% |
| Option 6 | 70% | 0 | 30% | 0 | 0 | 83.6% | 22.9% |
| Option 7 | 70% | 0 | 0 | 30% | 0 | 77.5% | 22.1% |
| Option 8 | 70% | 0 | 0 | 0 | 30% | 90.1% | 20.3% |

More specifically, the combination of coconut water and lettuce juice with orange juice produced favorable results. Surprisingly, the combination of coconut water and lettuce juice with 70% orange juice, shown in Option 4 of the chart, produced an even better FTC value than the 70% orange juice blends having only coconut water or only lettuce juice.

In particular, it was found that each lower-calorie liquid, when combined with a juice base, produced flavor attributes that noticeably differed from the attributes of the juice base by itself. However, the combination of the two lower-calorie liquids had a synergistic effect at reducing the individual attributes of the lower-calorie liquids that differed from the full-calorie juice base. For example, coconut water alone was generally associated with a salty attribute and lettuce juice alone was generally associated with a vegetable attribute. Some consumers might consider a salty or vegetal attribute as undesirable in a fruit juice beverage product. Surprisingly, when coconut water and lettuce juice were combined, the intensity of the salty and vegetal attributes were perceived to be reduced, resulting in an increased FTC.

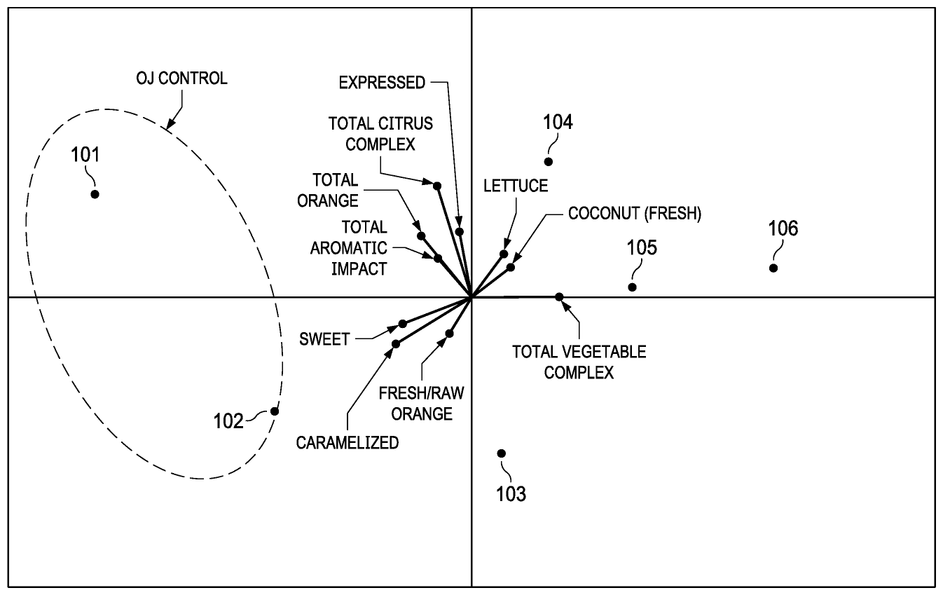

A second set of experiments focusing only on coconut water and lettuce juice with an orange juice base was completed. FIG. 1 is a principle component analysis chart depicting sensory attributes from these experiments. The following Table 3 is a summary of the formulations charted in FIG. 1. All percentages are by weight of the entire formulation.

TABLE 3

| Label Number | Formulation |
|---|---|
| 101 | Orange Juice Control |
| 102 | 85% Orange Juice |
| | 7.5% Coconut Water |
| | 7.5% Lettuce Juice |
| 103 | 85% Orange Juice |
| | 15% Coconut Water |
| 104 | 85% Orange Juice |
| | 15% Lettuce Juice |
| 105 | 76.25% Orange Juice |
| | 20% Coconut Water |
| | 3.75% Lettuce Juice |
| 106 | 76.25% Orange Juice |
| | 11.25% Coconut Water |
| | 12.5% Lettuce Juice |

In FIG. 1, the samples and attributes located close to one another on the plot are positively correlated. For example, the orange juice control 101 was more positively correlated with sample 102 made from 85% orange juice and an equal blend of lettuce juice and coconut water, when compared to blends having 85% orange juice with either only lettuce juice 104 or only coconut water 103. The study also found that the orange juice blend 105 having a higher ratio coconut water to lettuce was directionally more similar to 100% orange juice than the orange juice blend 106 having more lettuce juice than coconut water.

Other sensory methods were used to validate the results of experiments described above. For example, one of the methods employed included a Quantitative Descriptive Analysis (QDA®) with a trained sensory panel. The panel was trained to quantify attributes in the following categories: appearance (AP), flavor (FL), aroma (AR), and aftertaste (AF).

Table 4 shows the 100% orange juice control compared with a 70% orange juice blended with 30% lettuce juice, 70% orange juice blended with 30% coconut water, 70% orange juice blended with 15% coconut water and 15% lettuce juice, and 70% orange juice blended with 24% coconut water and 6% lettuce juice. Similar attributes were identified using Tukey's test with a 10% significance level. In Table 4 below, similar attributes are indicated by a check mark and dissimilar attributes are indicated by an “X”. The result showed that the juice beverage having the higher amounts of coconut water with lettuce juice had the highest number of similar attributes to the control. In particular, for 70% orange juice with 30% coconut water, 9 attributes were similar to control. For 70% orange juice with 15% coconut water and 15% lettuce juice, 15 attributes were similar to control. For 70% orange juice with 24% coconut water and 6% lettuce juice, 17 attributes were similar to control. For 70% orange juice with 30% lettuce juice, 13 attributes were similar to control.

TABLE 4

| | NFC OJ 70%, | | OJ 70%, CCW 15%, | | OJ 70%, CCW 24%, | | OJ 70%, | | TPP NFC OJ |
|---|---|---|---|---|---|---|---|---|---|
| Attribute | NFC CCW 30% | | Lett 15% | | Lett 6% | | Lett 30% | | CONTROL |
| AP Color, yellow to orange | 37.09 | X | 38.85 | ✓ | 37.42 | X | 40.62 | ✓ | 43.01 |
| AP Brightness | 40.25 | X | 48.97 | ✓ | 52.68 | ✓ | 54.22 | ✓ | 47.44 |
| AP Thickness/Viscosity | 33.38 | X | 31.55 | X | 29.17 | X | 34.15 | X | 42.29 |
| AP Opaqueness | 74.92 | X | 73.37 | X | 72.52 | X | 73.21 | X | 78.20 |
| AP Amount of Pulp/Granules | 13.39 | X | 15.89 | ✓ | 18.81 | ✓ | 15.76 | ✓ | 18.97 |
| AR Fresh Orange | 29.59 | ✓ | 26.36 | X | 27.49 | ✓ | 23.91 | X | 33.06 |
| AR Artificial Orange | 29.46 | X | 22.66 | ✓ | 24.77 | ✓ | 21.41 | ✓ | 22.25 |
| AR Citrus | 21.88 | ✓ | 28.89 | X | 27.88 | ✓ | 26.98 | ✓ | 24.17 |
| AR Bitter | 15.25 | ✓ | 15.85 | ✓ | 17.65 | ✓ | 19.52 | X | 14.38 |
| FL Flavor Strength | 62.12 | X | 61.09 | X | 61.7 | X | 64.02 | X | 69.56 |
| FL Fresh Orange | 27.38 | X | 26.89 | X | 27.03 | X | 23.25 | X | 39.70 |
| FL Artificial Orange Flavor | 43.21 | X | 30.96 | ✓ | 31.81 | ✓ | 36.69 | V | 32.28 |
| FL Concentrate | 45.15 | X | 45.67 | X | 45.47 | X | 47.26 | X | 38.44 |
| FL Citrus | 28.24 | ✓ | 37.43 | ✓ | 34.79 | ✓ | 37.4 | ✓ | 32.49 |
| FL Sweet | 30.82 | X | 30.99 | X | 33.46 | X | 25.04 | X | 42.94 |
| FL Sour | 37.65 | X | 37.93 | ✓ | 34.51 | V | 36.78 | ✓ | 31.50 |
| FLTangy | 34.45 | X | 45.91 | ✓ | 49.24 | ✓ | 45 | ✓ | 45.88 |
| FL Bitter | 21.63 | ✓ | 25.65 | X | 25.26 | X | 29.27 | X | 17.59 |
| FL Chemical | 37.83 | ✓ | 42.06 | X | 38.67 | X | 44.08 | X | 31.39 |
| FL Stale | 35.83 | X | 33.62 | X | 30.8 | ✓ | 39.14 | X | 26.18 |
| MF Bite | 25.74 | X | 31.32 | ✓ | 34.47 | V | 32.41 | ✓ | 31.60 |
| MF Thickness | 30.77 | X | 26.85 | X | 29.07 | X | 30.13 | X | 35.69 |
| AF Flavor Strength | 46.13 | X | 48.94 | ✓ | 48.09 | ✓ | 49.99 | ✓ | 53.59 |
| AF Fresh Orange | 20.42 | X | 23.75 | X | 25.03 | X | 20.44 | X | 32.86 |
| AF Sweet | 20.03 | X | 21.43 | X | 23.63 | X | 20.67 | X | 32.34 |
| AF Artificial Sweet | 16.46 | ✓ | 10.03 | ✓ | 10.92 | ✓ | 12.28 | ✓ | 13.00 |
| AF Bitter | 20.44 | ✓ | 22.84 | V | 18.38 | ✓ | 24.82 | X | 17.76 |
| AF Chemical | 29.41 | ✓ | 31.72 | X | 26.02 | V | 33.43 | X | 24.38 |
| AF Stale | 28.63 | X | 22.84 | ✓ | 20.84 | ✓ | 27.06 | X | 18.44 |
| AF Lasting | 37.77 | X | 46.47 | ✓ | 40.27 | X | 44.7 | ✓ | 46.36 |

Additional formulations were created to focus on enhancing the FTC of the blends in order to further emulate the orange juice base control. The enhancements were intended to fill in taste attributes such as citrus flavor and sweetness intensity that were reduced as a result of blending the lower-calorie liquids with the juice base. As shown in Example 4 of Table 1, 0.08 wt. % of sweetener enhancer (a Flavor with Modifying Properties (FMP) natural flavor from International Flavors & Fragrances Inc.) and 0.006 wt. % of orange flavor (citrus oils/keys) were added to a blend with 69.914 wt. % orange juice, 24 wt. % coconut water, and 6 wt. % lettuce juice. The flavor enhancement improved the FTC of the blend from 91.3% to 96.5% when compared to the similar blend of Example 1 in which no flavor enhancers were added. In an alternate example, blends produced to have 30% or higher sugar/Brix reduction were enhanced by adding stevia at about 70 ppm or higher depending on the sugar/Brix reduction level.

Other example formulations demonstrated that the preferred ratio of coconut water to lettuce juice may vary depending on the identity of the juice base. For example, a ratio of coconut water to lettuce juice may be modified in order to achieve a reduced Brix value in the juice blend while emulating the sensory profile of the juice base.

Referring back to Table 1, in Example 2, a green juice mixture containing juice from sweet potatoes, grapes, apples, bananas, mangoes, pineapple, oranges, carrots, limes, kale, and spinach was found to have improved taste when the lettuce juice concentration was higher than that of coconut water. For example, in one embodiment, 70% of the green juice was blended with 20.6% lettuce juice and 9.4% coconut water. The resulting green juice blend had a composite fit to control value of about 82.7% with a calculated Brix reduction of 23%. Attributes that were tested included total fruit juice flavor, pineapple flavor, banana flavor, total vegetable flavor, celery flavor, coconut flavor, sweetness, sourness, bitterness, astringent flavor, and mouth drying. In particular, the green juice base component had a Brix value of 12.2° Bx and the final juice blend with added coconut water and lettuce juice had a Brix value of 9.5° Bx. Surprisingly, acceptable combinations of lower-calorie liquids were different depending on the type of juice base. For example, the green juice base provided an acceptable blend when combined with higher amounts of lettuce juice as compared to coconut water. In contrast, the orange juice base provided an acceptable blend when combined with higher amounts of coconut water than lettuce juice.

In Example 3 of Table 1, an apple juice-based formulation was found to have improved taste when the coconut water concentration was higher than lettuce juice. For example, in one embodiment, 70% apple juice base was blended with 22% coconut water and 8% lettuce juice. The resulting apple juice blend resulted in a composite fit to control value of about 93% with a calculated sugar reduction of about 21%. Attributes that were tested included total apple, total aroma, total sweet, sweet aroma, honey, vegetable, lettuce, bitter astringent, and aftertaste. For example, the apple juice base component had a Brix value of 11.5° Bx, and the final juice blend with added coconut water and lettuce juice had a Brix value of 9.1° Bx.

While the disclosure has been illustrated and described in detail in the drawing and foregoing description, such an illustration and description is to be considered as exemplary and not restrictive in character, it being understood that only illustrative embodiments have been shown and described and that all changes and modifications that come within the spirit of the disclosure are desired to be protected.

Although the present disclosure has provided many examples and methods, it should be understood that, to the extent that elements are compatible, additional embodiments can be created by combining one or more elements from the various embodiments described herein. As an example, in some embodiments, a composition described herein can further comprise one or more elements of another composition described herein or a selected combination of elements from any combination of the compositions described herein.

Although embodiments of the invention have been described with reference to several elements, a skilled person, upon reading the present specification, would recognize that additional embodiments are effectively disclosed herein when elements can be omitted, substituted, added, combined, or rearranged as applicable to form new embodiments. Additionally, although the open-ended terms “comprises” and “includes” are generally used herein, additional embodiments can be formed by substituting the terms “consisting essentially of” or “consisting of.”

Additionally, when a value, values, a range, or ranges for a particular variable are given for one or more embodiments, an additional embodiment can be created by forming a new range whose endpoints are selected from any expressly listed values, or any individual value between the disclosed ranges.

There exist a plurality of advantages of the present disclosure arising from the various features of the compositions and methods described herein. It will be noted that alternative embodiments of the compositions and methods of the present disclosure may not include all of the features described yet still benefit from at least some of the advantages of such features. Those of ordinary skill in the art may readily devise their own implementations of the compositions and methods that incorporate one or more of the features of the present invention and fall within the spirit and scope of the present disclosure as defined by the appended claims.

### ADDITIONAL DISCLOSURE

The following descriptive embodiments are offered in further support of the disclosed invention:

In a first embodiment, novel aspects of the present disclosure are directed to a juice beverage comprising: from about 40 wt. % to about 85 wt. % of a juice base having a Brix value from about 7.5° Bx to about 25° Bx, wherein the juice base comprises at least one fruit juice; from about 5 wt. % to about 35 wt. % of a first liquid, wherein the first liquid is a juice and has a Brix value from about 2° Bx to about 7° Bx; and from about 3 wt. % to about 30 wt. % of a second liquid, wherein the second liquid is a juice and has a Brix value from about 1° Bx to about 6° Bx; wherein the Brix value of the second liquid is lower than the Brix value of the first liquid.

In another aspect of the first embodiment, the juice beverage comprises: from about 40 wt. % to about 85 wt. % of a juice base having a Brix value from about 7.5° Bx to about 25° Bx, wherein the juice base comprises at least one fruit juice; from about 5 wt. % to about 35 wt. % of a first liquid, wherein the first liquid is a juice and has a Brix value from about 2° Bx to about 7° Bx; and from about 3 wt. % to about 30 wt. % of a second liquid, wherein the second liquid is a juice and has a Brix value from about 1° Bx to about 6° Bx; wherein the Brix value of the second liquid is lower than the Brix value of the first liquid; and wherein the juice beverage further comprises one or more limitations selected from the following list:

wherein a weight ratio of the first liquid to the second liquid is from about 10:1 to about 1:1;

wherein the at least one fruit juice is selected from the group consisting of apricot, apple, orange, melon, grapefruit, lemon, lime, tangerine, tangelo, kumquat, mango, pear, peach, pineapple, cranberry, banana, papaya, passion fruit, grape, strawberry, raspberry, currant, blueberry, blackberry, acai, lychee, kiwi, pomegranate, aronia, and a green juice;

wherein the at least one fruit juice is orange juice;

wherein the juice base is a green juice;

wherein the first liquid is a juice selected from the group consisting of coconut, watermelon, beet, ginger, potato, sweet potato, winter melon, turnip, carrot, rutabaga, bamboo, birch, maple, cactus, aloe, sugarcane, and barley;

wherein the first liquid is coconut water;

wherein the second liquid is a juice selected from the group consisting of turnip, lettuce, collard greens, Swiss chard, arugula, watercress, tomato, celery, onion, cucumber, parsley, cilantro, basil, mint, fennel, dill, wheat grass, asparagus, artichoke, and olive;

wherein the second liquid is lettuce juice;

wherein the first liquid has a salty flavor that is attenuated by the presence of the second liquid;

wherein the second liquid has a vegetal flavor that is attenuated by the presence of the first liquid;

wherein the juice beverage has a fit to control value of at least 85% when attributes of the juice beverage are compared with attributes of the juice base using Quantitative Descriptive Analysis;

wherein the juice beverage is about 100% juice;

wherein the juice beverage further comprises citrus oil;

wherein the juice beverage consists of natural ingredients;

wherein the first liquid is coconut water and the second liquid is lettuce juice;

wherein the juice base has a first sugar concentration and the juice beverage has a second sugar concentration, wherein the second sugar concentration is about 20% to about 40% lower than the first sugar concentration; and

wherein the juice beverage further comprises stevia.

In a second embodiment, novel aspects of the present disclosure are directed to a method of making a juice beverage, the method comprising the steps of: providing a juice base having a Brix value from about 7.5° Bx to about 25° Bx, wherein the juice base comprises at least one fruit juice; providing a first liquid, wherein the first liquid is a juice and has a Brix value from about 2° Bx to about 7° Bx; providing a second liquid, wherein the second liquid is a juice and has a Brix value from about 1° Bx to about 6° Bx; and combining the juice base with the first liquid and the second liquid to produce the juice beverage, wherein the juice beverage comprises from about 40 wt. % to about 85 wt. % of the juice base, from about 5 wt. % to about 35 wt. % of the first liquid, and from about 3 wt. % to about 30 wt. % of a second liquid; wherein the Brix value of the second liquid is lower than the Brix value of the first liquid.

In a third embodiment, novel aspects of the present disclosure are directed to a juice beverage comprising: a juice base having a first Brix value, wherein the juice base comprises at least one fruit juice; a first liquid, wherein the first liquid is a juice and has a second Brix value; a second liquid, wherein the second liquid is a juice and has a third Brix value; wherein the third Brix value is lower than the second Brix value; wherein the juice beverage comprises a fourth Brix value; and wherein the fourth Brix value is 20% to 40% lower than the first Brix value.

1. A juice beverage comprising:
from about 40 wt. % to about 85 wt. % of a juice base having a Brix value from about 7.5° Bx to about 25° Bx, wherein the juice base comprises at least one fruit juice;
from about 5 wt. % to about 35 wt. % of a first liquid, wherein the first liquid is a juice and has a Brix value from about 2° Bx to about 7° Bx; and
from about 3 wt. % to about 30 wt. % of a second liquid, wherein the second liquid is a juice and has a Brix value from about 1° Bx to about 6° Bx;
wherein the fruit juice differs from each of the first liquid and the second liquid, the second liquid differs from the first liquid, and the Brix value of the second liquid is lower than the Brix value of the first liquid.

2. The juice beverage of claim 1, wherein a weight ratio of the first liquid to the second liquid is from about 10:1 to about 1:1.

3. The juice beverage of claim 1, wherein the at least one fruit juice is selected from the group consisting of apricot, apple, orange, melon, grapefruit, lemon, lime, tangerine, tangelo, kumquat, mango, pear, peach, pineapple, cranberry, banana, papaya, passion fruit, grape, strawberry, raspberry, currant, blueberry, blackberry, acai, lychee, kiwi, pomegranate, aronia, and a green juice.

4. The juice beverage of claim 1, wherein the at least one fruit juice is orange juice.

5. The juice beverage of claim 1, wherein the juice base is a green juice.

6. The juice beverage of claim 1, wherein the first liquid is a juice selected from the group consisting of coconut, watermelon, beet, ginger, potato, sweet potato, winter melon, turnip, carrot, rutabaga, bamboo, birch, maple, cactus, aloe, sugarcane, and barley.

7. The juice beverage of claim 1, wherein the first liquid is coconut water.

8. The juice beverage of claim 1, wherein the second liquid is a juice selected from the group consisting of turnip, lettuce, collard greens, Swiss chard, arugula, watercress, tomato, celery, onion, cucumber, parsley, cilantro, basil, mint, fennel, dill, wheat grass, asparagus, artichoke, and olive.

9. The juice beverage of claim 1, wherein the second liquid is lettuce juice.

10. The juice beverage of claim 1, wherein the first liquid has a salty flavor that is attenuated by the presence of the second liquid.

11. The juice beverage of claim 1, wherein the second liquid has a vegetal flavor that is attenuated by the presence of the first liquid.

12. The juice beverage of claim 1, wherein the juice beverage has a fit to control value of at least 85% when attributes of the juice beverage are compared with attributes of the juice base using Quantitative Descriptive Analysis.

13. The juice beverage of claim 1, wherein the juice beverage is about 100% juice.

14. The juice beverage of claim 1 further comprising citrus oil.

15. The juice beverage of claim 1, wherein the juice beverage consists of natural ingredients.

16. The juice beverage of claim 1, wherein the first liquid is coconut water and the second liquid is lettuce juice.

17. The juice beverage of claim 1, wherein the juice base has a first sugar concentration and the juice beverage has a second sugar concentration, wherein the second sugar concentration is about 20% to about 40% lower than the first sugar concentration.

18. The juice beverage of claim 1, further comprising stevia.

19. A method of making a juice beverage, the method comprising
providing a juice base having a Brix value from about 7.5° Bx to about 25° Bx, wherein the juice base comprises at least one fruit juice;
providing a first liquid, wherein the first liquid is a juice and has a Brix value from about 2° Bx to about 7° Bx;
providing a second liquid, wherein the second liquid is a juice and has a Brix value from about 1° Bx to about 6° Bx; and
combining the juice base with the first liquid and the second liquid to produce the juice beverage, wherein the juice beverage comprises from about 40 wt. % to about 85 wt. % of the juice base, from about 5 wt. % to about 35 wt. % of the first liquid, and from about 3 wt. % to about 30 wt. % of a second liquid;
wherein the Brix value of the second liquid is lower than the Brix value of the first liquid.

20. A juice beverage comprising:
a juice base having a first Brix value, wherein the juice base comprises at least one fruit juice;
a first liquid, wherein the first liquid is a juice and has a second Brix value;
a second liquid, wherein the second liquid is a juice and has a third Brix value;
wherein the third Brix value is lower than the second Brix value;
wherein the juice beverage comprises a fourth Brix value; and
wherein the fourth Brix value is 20% to 40% lower than the first Brix value.
